(19) United States
(12) Patent Application Publication
(10) Pub. No.: US 2002/0142906 A1
(43) Pub. Date: Oct. 3, 2002

(54) Device for forming box joining flaps in a box splitting machine

(76) Inventor: Rinaldo Benzoni, Lissone (IT)

Correspondence Address: James V. Costigan, Esq., HEDMAN & COSTIGAN, P.C., Suite 2003, 1185 Avenue of the Americas, New York, NY, 10036-2646, US

(21) Appl. No.: 10/113,349

(22) Filed: Apr. 1, 2002

(30) Foreign Application Priority Data
Apr. 3, 2001 (IT) MI2001A 000716

(51) Int. Cl. B31B 1/20

(52) U.S. Cl. 493/363; 493/370

(57) ABSTRACT

An improved device for forming box joining flaps in a box splitting machine comprises a supporting frame for supporting a joining flap cutting assembly, the supporting frame being transversely driven with respect to the paperboard material feeding direction, by a worm screw in turn driven by a geared motor unit controlled by a controlling electronic apparatus.

### BACKGROUND OF THE INVENTION

The present invention relates to an improved device, for application to a splitting machine, designed for processing corrugated board material, to make product packaging boxes and the like.

As is known, the splitting machine are designed for making suitable split and ribbed arrangements in the corrugated paperboard material, which is supplied, with a flat arrangement, at one end of the splitting machine.

The corrugated board portions, in particular, are trimmed, ribbed and die-cut, so as to be adapted for bending to make packaging boxes.

Prior paperboard material splitting or die-cutting machines, however, are affected by several drawbacks, mainly related to the machine portions which are used for forming, at one side end, the box joining or jointing flap.

Such a joining flap, more specifically, is a paperboard material side flap, which is used for closing the box by glueing or seaming.

Such a glueing or seaming operation, in particular, is at present performed by mechanical means, i.e. mechanical devices including a plurality of rotary blades, which are mounted on a top cutting blade supporting disc.

The cutting blades are arranged with a suitably slanted or inclined arrangement with respect to the cutting blade supporting disc and cooperate with abutment rings rotatively driven together with a bottom counter-splitting disc.

Thus, prior paperboard material splitting or die-cutting machines require a lot of labour consuming adjusting operations, since the mentioned bottom abutment rings, which are usually made of a polyurethane material, are quickly worn.

In a further prior embodiment, the mentioned bottom abutment rings are made of a hardened steel material.

In this case, on the other hand, it is necessary to manually adjust the cutting depth of the cutting blades, depending on the thickness of the paperboard material being processed.

Such an adjusting operation is necessary for preventing the joining flap cutting blades from being quickly worn, as well as to prevent the cutting blade holder shafts and bearings from being also quickly worn because of a comparatively high operating load.

Yet another prior paperboard material splitting or die-cutting machine provides to use top joining flap cutting blades, which are mounted in supporting recesses therefor, including a plurality of resilient spring or pressing-elements, urging the cutting blades so as to provide a suitable cutting pressure.

In this case too, the joining flap cutting blades work in cooperation with bottom abutment ring elements, made of a hardened steel material, mounted on a counter-splitting member.

While the latter paperboard material splitting machine is preferred with respect to the other above disclosed splitting or die-cutting machine, it, however, presents the drawback that it cannot be easily fitted, in its cutting pressure, to the different thicknesses of paperboard materials to be split or cut.

For example, as a joining flap is to be cut from a paperboard material having a thickness of 10 mm, then it would be necessary to provide a resilient spring adapted to apply a suitable cutting pressure, which must be comparatively high.

On the other hand, as, by the same machine, a paperboard material having a thickness of only 3 mm must be cut, then it is necessary to cause the steel ring element mounted on the bottom abutment splitting element to be approached, since it is necessary to drive towards one another the disc elements provided for allowing the paperboard material to be properly fed.

Under the above mentioned conditions, the joining flap cutting blades would excessively cut through the paperboard material because of a greater pressure of the spring, with a consequent quick wearing of the cutting blades.

Moreover, said cutting blades, also in this case, would apply an excessively great load on the cutting blade bearing shafts and bearing assemblies, thereby causing either a temporaneous or permanent flexure of said shafts and a quick wearing of the bearings.

Moreover, all the above disclose paperboard material splitting or die-cutting machines are affected by further drawbacks.

One of the latter is that as packages without joining flaps must be made, then it is necessary to manually disassemble the joining flap cutting blades, and then assemble them again for processing boxes including the joining flaps.

Furthermore, if a joining flap having a length greater than the height of a closed box must be made, then it is necessary to manually drive the cutting blades, with consequent complex operations to be performed by skilled operators.

### SUMMARY OF THE INVENTION

Thus, the aim of the present invention is to provide such an improved device for forming joining flaps in box die-cutting or splitting machines, which allows to automatize and greatly simplify all the adjusting operations, so as to reduce to a minimum the wearing of the cutting blades.

Within the scope of the above mentioned aim, a main object of the present invention is to provide such an improved device which, for operation, does not require to disassemble the cutting blades for making boxes either including or not the joining flaps, or boxes including a greater length joining flap.

Another object of the present invention is to provide such an improved device allowing to fully eliminate any stresses from the cutting blade supporting bearings and rollers.

In fact, the joining flap cutting blades are mounted on a dedicated mounting assembly, located outside of the paperboard material splitting or die-cutting machine.

Thus, such a dedicated and outside joining flap cutting assembly does not require any manual adjusting for use, with the exception of the adjustment operations required for fitting the processed paperboard material thicknesses.

Moreover, the subject improved assembly allows to easily make joining flaps of any desired lengths, which could not be obtained in the above disclosed prior devices.

In fact, in the latter, the maximum length of the joining flap depends on the peripheral extension of the cutting blade supporting disc thereon are mounted the joining flap cutting blades.

Moreover, the device according to the invention provides the further advantage that it can be applied to all the existing paperboard material splitting or die-cutting machine, and, more specifically, at the paperboard material inlet and output sides thereof.

The device according to the present invention, moreover further comprises a trimming assembly for precisely trimming the processed paperboard material and for allowing a suitable fragmentation of the trim arrangement to be easily made. The latter feature, in particular, would greatly facilitate the removal of the paperboard material trimmed waste thereby preventing any jamming from occurring.

The device for trimming and fragmentating the processed paperboard material does not require any pressure adjustments, with respect to the trim breaking blade, while providing all the disclosed operating advantages of the joining flap cutting assembly.

### BRIEF DESCRIPTION OF THE DRAWINGS

Further characteristics and advantages of the improved device according to the present invention will become more apparent hereinafter from the following detailed disclosure with reference to the accompanying drawings, where:

FIG. 1 is a front side view illustrating the improved device according to the invention;

FIG. 2 is a side perspective view illustrating a detail of the assembly for making box joining flaps;

FIG. 3 is a side view illustrating the box joining flap making assembly;

FIG. 4 is a detail view of the cutting blade supporting elements, designed for supporting a plurality of joining flap cutting blade;

FIG. 5 is a side orthogonal view of the box joining flap making assembly;

FIG. 6 is a side view showing the trimming assembly for trimming one end of a box, made by using a paperboard material splitting or die-cutting machine;

FIG. 7 illustrates a side view, orthogonal to the view of FIG. 6;

FIG. 8 is a top side perspective view of the trimming assembly for trimming a side end of the paperboard boxes;

FIG. 9 is a further top side perspective view of the box joining flap making assembly;

FIG. 10 is a schematic top plan view of an extended box, this view clearly showing the trimming operations for trimming one end of a box and for cutting the box joining flaps, at the end of the box opposite to the trimming end.

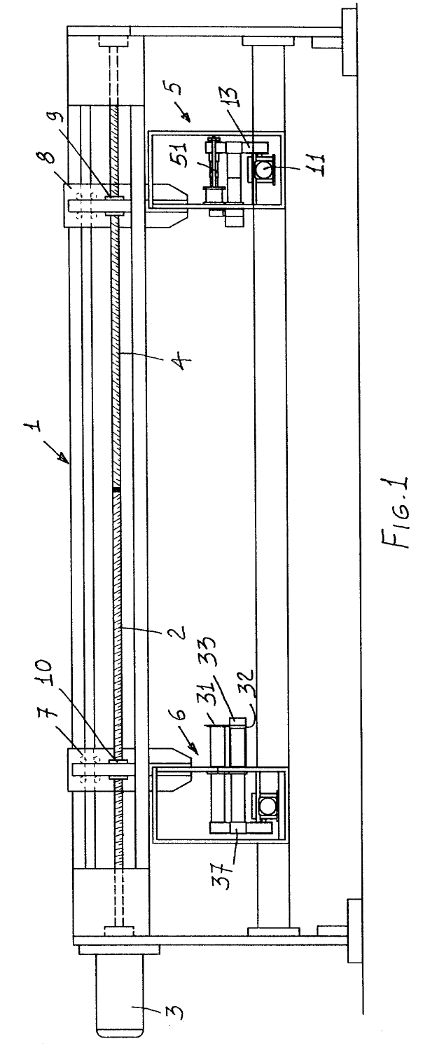

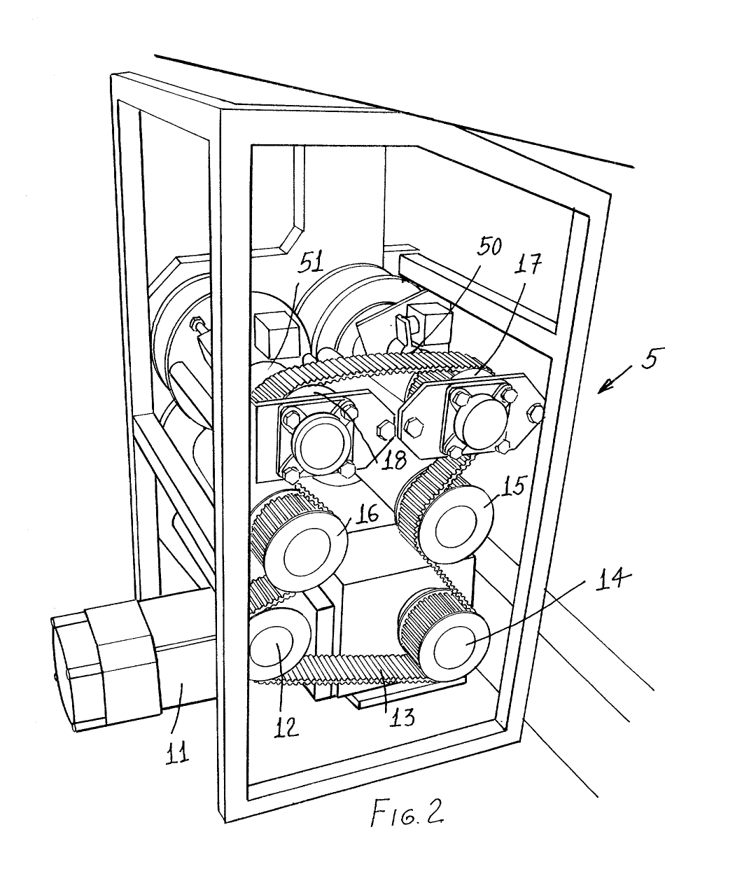

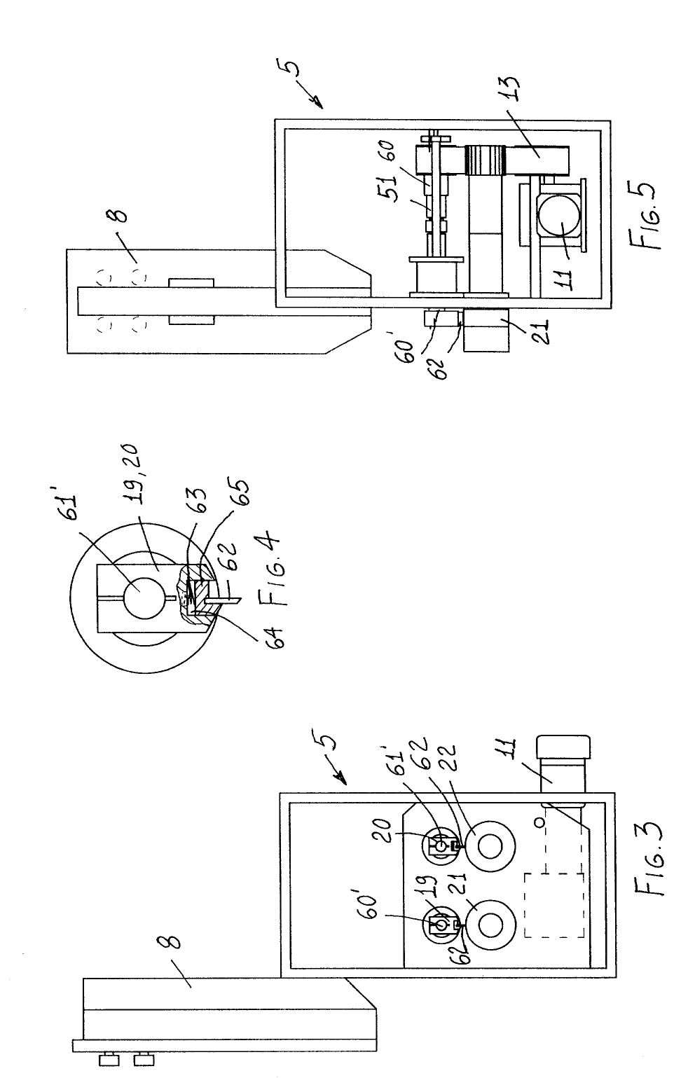

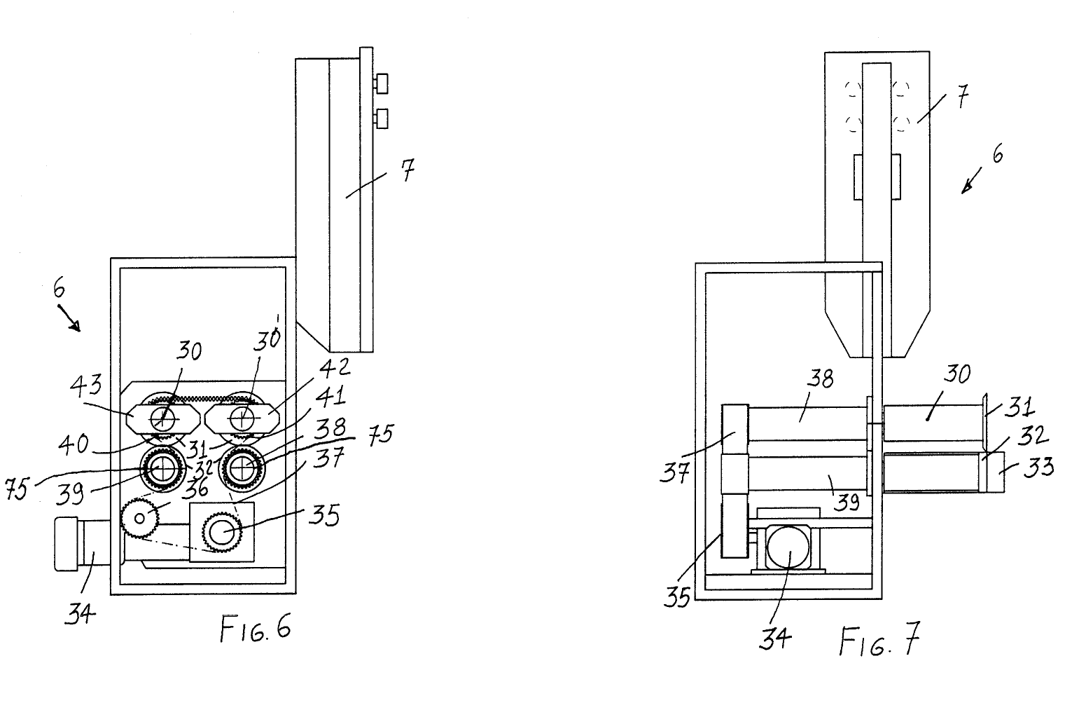

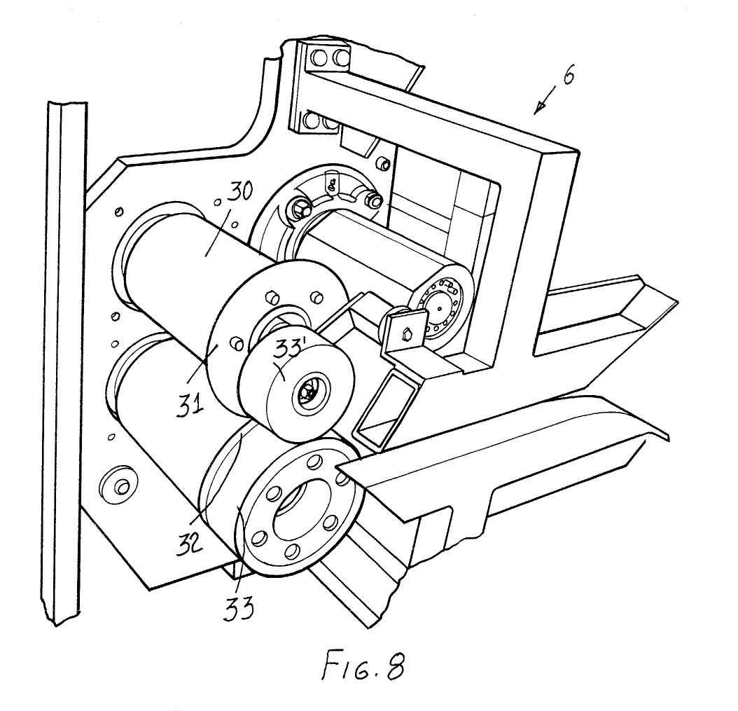

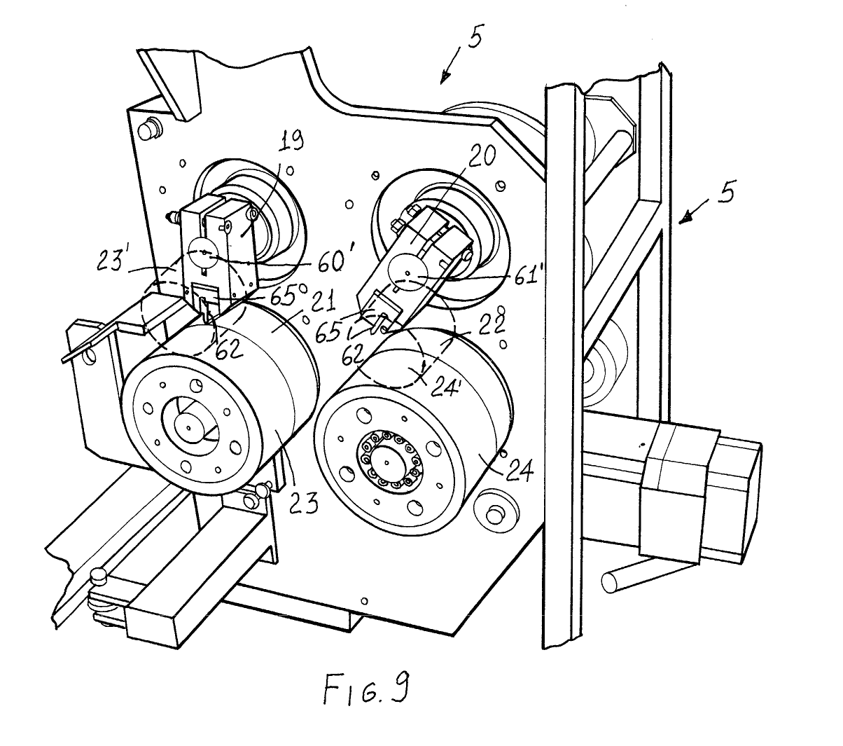

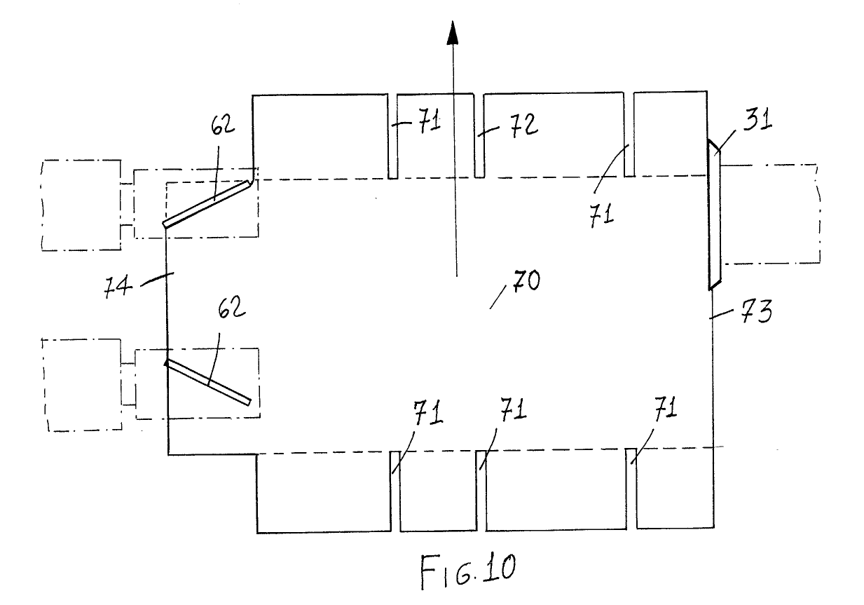

### DESCRIPTION OF THE PREFERRED EMBODIMENTS

With reference to the number references of the figures of the accompanying drawings, the improved device according to the present invention comprises a flap cutting assembly, supported on a framework 5 which can be driven transversely of the paperboard material feeding direction.

In particular, the framework 5 is driven by a worm screw 4, in turn driven by a geared motor unit, controlled by a specifically designed electronic apparatus.

The geared motor unit 11 is supported by said framework 5 for operatively driving, through a toothed pulley 14, a toothed belt 13.

In this connection it should be pointed out that the above driving belt arrangement could be replaced by a chain and pinion driving assembly.

The belt 13 rotatively drives at least four toothed pulleys 15, 16, 17 and 18 which are rigid with corresponding rotatively driven shafts.

In particular, the two top shafts 60 and 61, as suitably supported, comprise two friction assemblies 51, which are electrically driven, for allowing motion to be transmitted from a primary shaft 60 and 61 to a secondary shaft 60′ and 61′, at electronically preset time periods.

Alternatively, the two shafts 60 and 61 can be driven by electronically controlled motors.

As shown, the secondary shafts 60′ and 61′ support two rotary devices 19 and 20 in turn supporting a plurality of cutting blades or knives 62.

Thus, as the rotary devices 19 and 20 are rotatively driven, the cutting blades will respectively cut a paperboard material side flap, thereby forming the box paperboard flap 74, the length of which will be electronically preset, in setting the box dimensions.

The joining flap 74 cutting blades 62, during the paperboard material cutting operation, turn with two bottom ring elements 21 and 22 made of a hardened steel material.

The bottom ring elements 21 and 22 adjoin two further ring elements 23 and 24 coated by a rubber material and which, in tun, cooperate with top rubber wheels 23′ and 24′ supported by spring-urged arms.

Said ring elements 23 and 24 and wheels 23′ and 24′ rotate with a peripheral speed equal to that of the splitting and counter-splitting discs of the splitting machine.

Thus, the ring elements 23 and 24 and wheels 23′ and 24′ will cause the paperboard material to be evenly fed for cutting the joining flaps therefrom.

In this connection it should be pointed out that the joining flap blades 62, supported by the two top secondary shafts 60′ and 61′ comprise resilient material spacer elements, allowing the cutting blades 62 to be urged by a constant pressure, thereby providing a perfect cutting of the joining flaps, independently from the paperboard material thickness and type or quality.

The auxiliary trimming device for application to the paperboard material splitting machine and to corrugated paperboard material processing machines in general, comprises a supporting framework 6 which can be driven transversely of the paperboad material feeding direction.

The supporting framework 6, in particular, is preferably driven by a geared motor unit 3, rotatively driving a worm screw 2 engaging with a ring-nut 10 applied to said supporting framework 6.

A second geared motor unit 34 drives either a toothed pulley 35 or a pinion.

The pulley 35, in turn, drives, through a toothed belt 37, at least four pulleys 40, 41 and 75, which are rigid with four shafts 30, 30′, 38 and 39.

Two of said shafts, i.e. a top shaft and a bottom shaft, respectively support a blade 31 and a counter-blade 32 for trimming a side flaps 73 of the paperboard material.

The rotary shaft 30′ supports one or more top cross cutting blades 42 cooperating with a bottom roller, made of a steel material or coated by a polyurethane material 32, thereby transversely pre-cutting the paperboard material portion to be trimmed.

The subject device further comprises, on the two sides thereof, spring-urged rubber wheels, cooperating with rubber coated ring elements for providing a perfect and even feeding of the paperboard material.

1. An improved device, to be applied to paperboard material splitting machines, for forming box joining-flaps, characterized in that said device comprises a supporting framework for supporting a joining flap cutting assembly, said supporting framework being driven transversely of the paperboard material feeding direction, as controlled by a worm screw in turn driven by an electronically controlled geared motor unit.

2. An improved device according to claim 1, characterized in that said joining-flap cutting assembly comprises a supporting framework supporting a geared motor unit which, through a toothed pulley, drives a toothed belt.

3. An improved device according to claim 1, characterized in that said supporting framework is driven by a chain-pinion assembly.

4. An improved device according to claim 2, characterized in that said toothed belt rotatively drives at least four toothed pulleys, which are rigid with corresponding rotary shafts.

5. An improved device according to claim 4, characterized in that said shafts comprise two top shafts supporting two mechanical friction assemblies, or electrically driven assemblies, for allowing motion to be transmitted from a primary shaft to a secondary shaft at mechanically or electronically set time periods.

6. An improved device according to claim 5, characterized in that said secondary shafts support two cutting blade supporting rotary devices.

7. An improved device according to claim 6, characterized in that, as said cutting blade supporting rotary devices are rotatively driven, they respectively cut a front and rear flap of the paperboard material, thereby providing the box paperboard joining flap, the length of said joining flap being electronically preset as the box dimensions are set.

8. An improved device according to claim 7, characterized in that said joining flap cutting blades are rotatively driven, for cutting the paperboard material, in cooperation with two bottom hardened steel ring elements.

9. An improved device according to claim 8, characterized in that said hardened steel bottom ring elements adjoin two further rubber coated ring elements which cooperate with top rubber wheel supported by spring-urged arms.

10. An improved device according to claim 9, characterized in that said rubber coated ring elements and wheels turn with a peripheral speed equal to that of the paperboard splitting and counter-splitting discs of the paperboard splitting machine.

11. An improved device according to claim 10, characterized in that said rubber coated ring elements and wheels cause said paperboard material to be evenly fed as said joining flap is cut therefrom.

12. An improved device according to claim 9, characterized in that said joining flap cutting blades, supported by said two top secondary shafts, comprise resilient material spacer elements applying on the cutting blades an even pressure so as to cut the joining flap independently from the thickness and type of the paperboard material.

13. An improved device according to claim 1, characterized in that said device further comprises an auxiliary trimming assembly, for application to paperboard material splitting or die-cutting machines and to corrugated board processing machines in general, said trimming assembly comprising a supporting framework which can be driven transversely of the paperboard material feeding direction.

14. An improved device according to claim 13, characterized in that said -supporting framework is driven by a geared motor assembly rotatively driving a worm screw engaging with a ring-nut applied to said auxiliary supporting framework.

15. An improved device according to claim 1, characterized in that said device comprises a second geared motor unit driving a toothed pulley or a pinion.

16. An improved device according to claim 15, characterized in that said toothed pulley drives, through a toothed belt, a plurality of pulleys rigid with at least four shafts.

17. An improved device according to claim 16, characterized in that two of said four shafts, i.e. a top shaft and a bottom shaft, respectively support a cutting blade and a cutting counter-blade, for trimming a side flap of said paperboard material.

18. An improved device according to claim 17, characterized in that the other two shafts of said four shafts, which are also rotatively driven, respectively support one or more top cross cutting blades.

19. An improved device according to claim 18, characterized in that said one or more top cross cutting blades cooperate with a- bottom roller, made of a steel material or of a polyurethane coated material, thereby cross pre-cutting the paperboard material portion to be trimmed.
